(19) United States
(12) Patent Application Publication
(10) Pub. No.: US 2019/0291574 A1
(43) Pub. Date: Sep. 26, 2019

(54) FUEL TANK FOR VEHICLES

(71) Applicant: HONDA MOTOR CO., LTD., Tokyo (JP)

(72) Inventors: Daijiro Ichikawa, Wako-shi (JP); Takeharu Yoshihashi, Wako-shi (JP)

(73) Assignee: HONDA MOTOR CO., LTD., Tokyo (JP)

(21) Appl. No.: 16/359,411

(22) Filed: Mar. 20, 2019

(30) Foreign Application Priority Data
Mar. 20, 2018 (JP) 2018-051908

(51) Int. Cl. B60K 15/077

(52) U.S. Cl. CPC B60K 15/077; B60K 2015/03111; B60K 2015/0775

(57) ABSTRACT

A wave eliminating plate 12 located within a tank shell 11 is provided with inflow ports 15A, 15B into which a fuel moving within the tank shell 11 flows and outflow ports 17A, 17B from which the fuel flowing from the inflow ports 15A, 15B flows in a different direction from an inflow direction. In addition, by inertia force due to the acceleration, deceleration, turning or the like of a vehicle, the fuel moving within the tank shell 11 is caused to change the flow direction while it flows from the inflow ports 15A, 15B of the wave eliminating plate 12 and flows out of the outflow ports 17A, 17B so that the fuel flowing out of the outflow ports 17A, 17B generates a vortex.

### CROSS-REFERENCE OF RELATED APPLICATION

This application claims priority of Japanese Patent Application No. 2018-051908 filed in Japan on Mar. 20, 2018, the entire contents of which are incorporated herein by reference.

### TECHNICAL FIELD

The present invention relates to a fuel tank for vehicles provided with a wave eliminating (wave phase cancellation) plate within a tank shell.

### BACKGROUND OF THE INVENTION

Guide walls 35, 36 made of a pair of plate materials of which each end is bent in the direction separating from each other are vertically arranged on a bottom wall of a tank shell of a fuel tank and a passage 37 is formed between both guide walls 35, 36. Guide members 38, 39 made of plate materials with a 3-shaped cross section are vertically arranged to face the exit of the passage 37, thereby guiding a fuel moving within the tank shell in one direction by the passage 37. The fuel is then caused to change its direction 180 degrees by the guide members 38, 39 to move along the side wall of the tank shell and as a result, noise generating when the fuel collides with the wall surface of the tank shell can be suppressed. The above fact has become publicly known by Japanese Translation of PCT International Application Publication No. 2001-511736.

By the way, referring to the conventional fuel tank stated above, since a plurality of guide walls 35, 36 and guide members 38, 39 are required to be vertically arranged on a bottom wall of the tank shell, it is intricate in configuration and makes its assembling operation troublesome. In addition, since the moving direction of the fuel is only deflected by the guide walls 35, 36 and the guide members 38, 39, there was a possibility that the moving speed of the fuel could not be sufficiently reduced and also necessary noise-reduction effects could not be obtained.

Thus, in consideration of the circumstances stated above, there is a need to provide a fuel tank for vehicles having a wave eliminating plate which is simple in configuration and can exhibit sufficient noise-reduction effects.

### SUMMARY OF THE INVENTION

In a first embodiment according to the present invention, a fuel tank for vehicles provided with a wave eliminating plate within a tank shell is proposed, in which the wave eliminating plate comprises an inflow port into which a fuel moving within the tank shell flows and an outflow port from which the fuel flowing from the inflow port flows in a different direction from an inflow direction.

According to a second embodiment, in addition to the structure of the first embodiment, the fuel tank for vehicles is proposed, in which the wave eliminating plate is located in a vehicle width direction, the inflow port opens in the longitudinal (vehicle's front-to-rear) direction and the outflow port opens in the vehicle width direction, wherein the inflow port and the outflow port are connected by an inclined wall which is inclined to the longitudinal direction and the vehicle width direction.

Also, according to a third embodiment, in addition to the structure of the second embodiment, the fuel tank for vehicles is proposed, in which the inflow port comprises the first inflow port situated on one side in the vehicle width direction and the second inflow port situated on the other side in the vehicle width direction, while the outflow port comprises the first outflow port adapted to communicate with the first inflow port and the second outflow port adapted to communicate with the second inflow port, wherein the first outflow port opens on one side in the vehicle width direction on one side in the longitudinal direction than the first outflow port, while the second outflow port opens on the other side in the vehicle width direction on the other side in the longitudinal direction than the second inflow port.

According to a fourth embodiment, in addition to the structure of the third embodiment, the fuel tank for vehicles is proposed, in which the wave eliminating plate is located approximately in the central part in the longitudinal direction of the tank shell.

Further, according to a fifth embodiment, in addition to the structure of any one of the first to fourth embodiments, the fuel tank for vehicles is proposed, in which the inclined wall is provided to linearly connect the inflow port and the outflow port.

Still further, according to a sixth embodiment, in addition to the structure of any one of the first to fifth embodiments, the fuel tank for vehicles is proposed, in which the wave eliminating plate is provided with a top plate along the lower surface of an upper wall of the tank shell.

It is to be noted that the first inflow port 15A and the second inflow port 15B of the embodiment correspond to the inflow port according to the present invention, the first inclined wall 16A and the second inclined wall 16B of the embodiment correspond to the inclined wall of the present invention, and the first outflow port 17A and the second outflow port 17B of the embodiment correspond to the outflow port according to the present invention, respectively.

### Effect of the Embodiments of the Invention

According to the structure of the first embodiment of the present invention, since the wave eliminating plate located within the tank shell comprises the inflow port into which a fuel moving within the tank shell flows and the outflow port from which the fuel flowing from the inflow port flows in a different direction from an inflow direction, the wave eliminating plate becomes simple in configuration to make its assembly operation to the tank shell easy. Furthermore, by the inertia force due to acceleration, deceleration, turning of the vehicle or the like, the fuel moving within the tank shell is caused to change its flow direction while it flows from the inflow port of the wave eliminating plate and flows out of the outflow port and the fuel flowing out of the outflow port generates a vortex. As a result, by effectively reducing the moving speed of the fuel by the vortex, it is possible to suppress the fuel level from vertically fluctuating to cause ruffles and to reduce the noise generating by the collision of the fuel with the side wall and the upper wall of the tank shell.

Further, according to the structure of the second embodiment, since the wave eliminating plate is located in a vehicle width direction, the inflow port opens in the longitudinal direction, the outflow port opens in the vehicle width direction, and the inflow port and the outflow port are connected by the inclined wall which is inclined to the longitudinal direction and to the vehicle width direction, the fuel moving in the longitudinal direction is caused to change its direction to the vehicle width direction by the inclined wall to generate a vortex and the moving speed of the fuel is reduced. As a result, when the fuel moves in the longitudinal direction by the acceleration or deceleration of the vehicle, the noise generated by the collision of the fuel with the front wall, the rear wall or the upper wall of the tank shell can be reduced effectively.

Still further, according to the structure of the third embodiment, since the inflow port comprises the first inflow port situated on one side in the vehicle width direction and the second inflow port situated on the other side in the vehicle width direction, the outflow port comprises the first outflow port adapted to communicate with the first inflow port and the second outflow port adapted to communicate with the second inflow port, the first outflow port opens on one side in the vehicle width direction on one side in the longitudinal direction than the first inflow port, while the second outflow port opens on the other side in the vehicle width direction on the other side in the longitudinal direction than the second inflow port, the fuel moving on one side in the longitudinal direction generates a vortex in a space on one side in the longitudinal direction and on one side in the vehicle width direction of the tank shell, while the fuel moving on the other side in the longitudinal direction generates a vortex in a space on the other side in the longitudinal direction of and on the other side in the vehicle width direction of the tank shell, thereby being capable of exhibiting a noise-reduction effect over the whole area of a period when the fuel reciprocates in the longitudinal direction.

Also, according to the structure of the fourth embodiment, since the wave eliminating plate is located approximately in the central part in the longitudinal direction of the tank shell, it is possible to evenly secure a space generating the vortex at the front or rear sections of the tank shell, thereby being capable of exhibiting the effective noise-reduction effect irrespective of the moving direction of the fuel.

According to the structure of the fifth embodiment, since the inclined wall is provided to linearly connect the inflow port and the outflow port, the flow of fuel from the inflow port to the outflow port becomes smooth compared to the inclined wall of a bent shape, thereby being capable of generating the vortex effectively.

Also, according to the structure of the sixth embodiment, since the wave eliminating plate is provided with a top plate along the lower surface of an upper wall of the tank shell, when the fuel tank becomes almost full, it is possible to block the fuel which is jumping up after colliding with the wave eliminating plate by the top plate and to exhibit the further noise-reduction effect by not letting the fuel collide with the upper wall of the tank shell.

### BRIEF DESCRIPTION OF THE DRAWINGS

FIG. 1 is a plan view of a fuel tank for vehicles;

FIG. 2 is a cross-sectional view taken along lines 2-2 of FIG. 1;

FIG. 3 is a cross-sectional view taken along lines 3-3 of FIG. 2; and

FIG. 4 is a perspective view of a wave eliminating plate.

### DETAILED DESCRIPTION OF EMBODIMENTS OF THE INVENTION

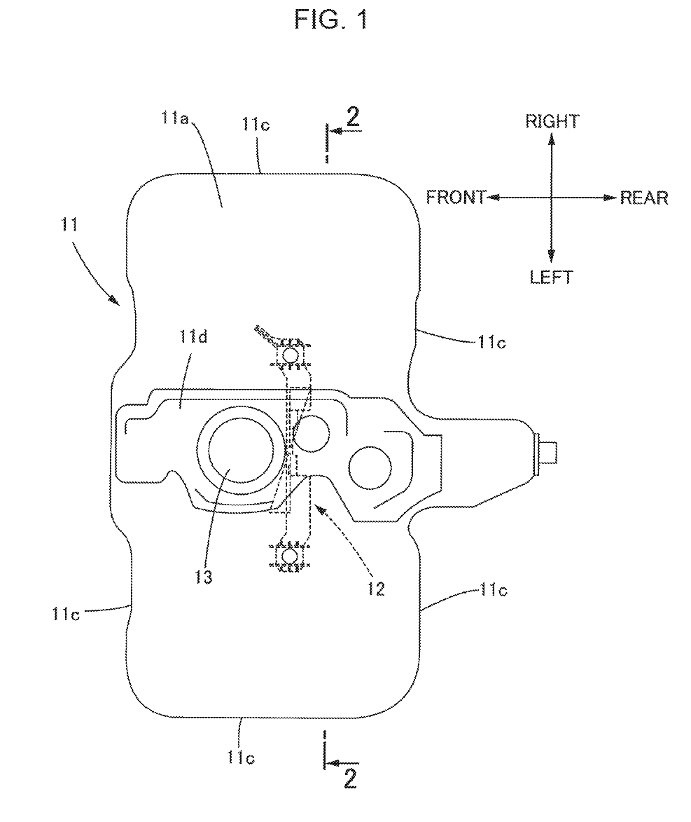

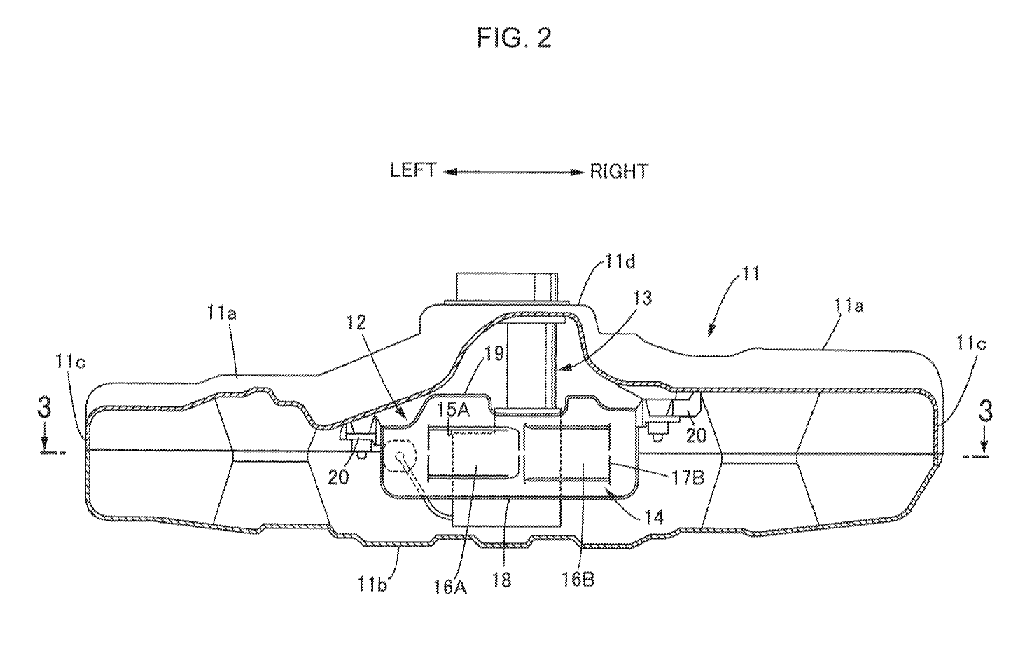

A preferred embodiment of the present invention will now be described with reference to FIGS. 1 to 4. In the present specification, it is to be noted that the longitudinal (front-to-rear) direction, the vehicle width direction (the horizontal direction), and the vertical direction of the fuel tank are defined on the basis of a vehicle on which the fuel tank is mounted.

As shown in FIGS. 1 to 3, a tank shell 11 of a fuel tank located under the right and left front seats of a vehicle is provided with an upper wall 11a, a lower wall lib and a side wall 11c, while, in the central part in the vehicle width direction of the upper wall 11a, an upwardly rising raised section 11d is formed to protrude within a center console of the vehicle. Located in a space below the raised section 11d of the tank shell 11 is a wave eliminating plate 12 of a approximately plate shape which extends in the vehicle width direction. Also, located immediately in front of the wave eliminating plate 12 is an in-tank type fuel pump 13.

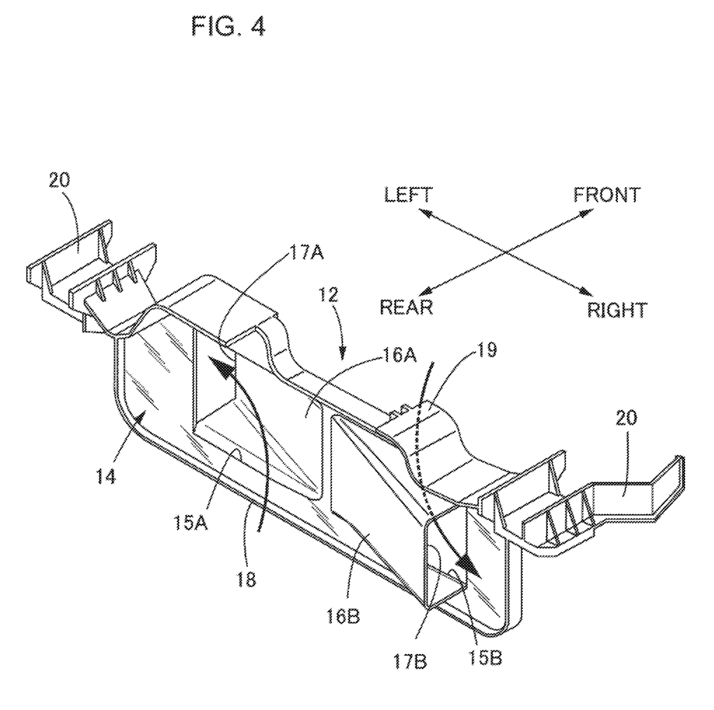

As is obvious from FIG. 4, a main body 14 of the wave eliminating plate 12 is made of an approximately rectangular-shaped metal plate, and the wave eliminating plate 12 is located inside the tank shell 11 such that the main body 14 extends in the vehicle width direction. By pressing a portion of the left side of the main body 14 in the vehicle width direction to allow the portion to diverge from the main body 14, the first inflow port 15A, the first inclined wall 16A, and the first outflow port 17A are formed in the wave eliminating plate 12, forming a duct or channel in a manner that linearly connects the first inflow port 15A and the first outflow port 17A. The first inflow port 15A opens on a fundamental plane of the main body 14, the first inclined wall 16A extends obliquely from the right edge of the first inflow port 15A to the front and to the left, and the first outflow port 17A opens to the left to connect the left edge of the first inflow port 15A and the left edge of the first inclined wall 16A. Similarly, by pressing a portion of the right side of the main body 14 in the vehicle width direction, the second inflow port 15B, the second inclined wall 16B and the second outflow port 17B are formed in the wave eliminating plate 12, forming a duct or channel in a manner that linearly connects the second inflow port 15BA and the second outflow port 17B. The second inflow port 15B opens on a fundamental plane of the main body 14, the second inclined wall 16B extends obliquely in a linear arrangement from the left edge of the second inflow port 15B to the front and to the right, and the second outflow port 17B opens to the right to connect the right edge of the second inflow port 15B and the right edge of the second inclined wall 16B.

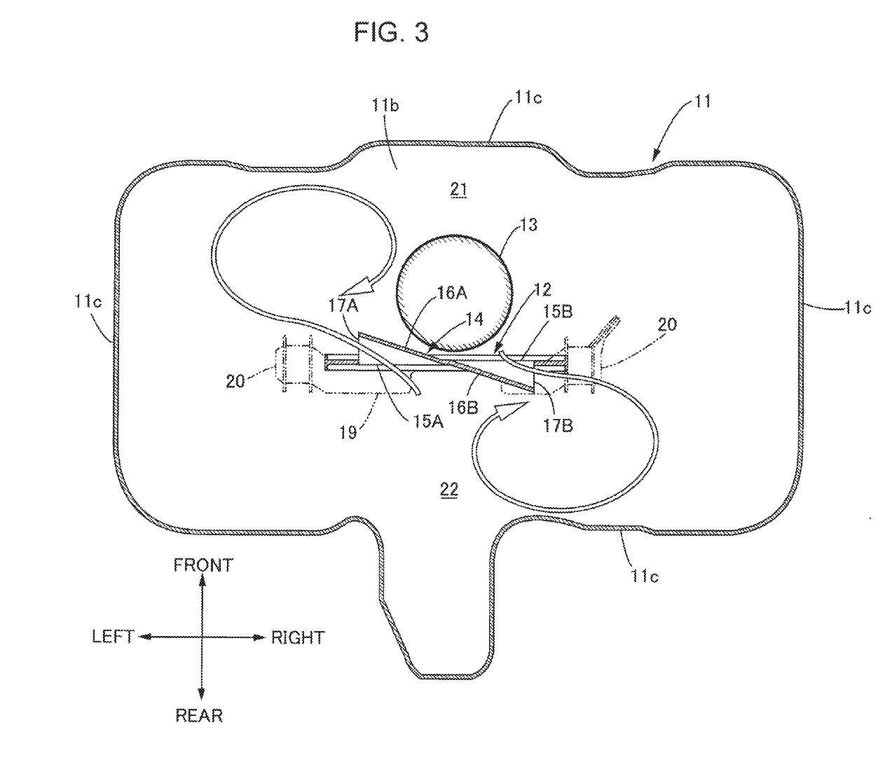

Attached to both the right and left edges of the main body 14 and to its lower edge is a flange 18 to increase the rigidity and attached to the upper edge of the main body 14 is a top plate 19 of which the width in the longitudinal direction is larger than the flange 18. Further, stays 20, 20 are provided on both the right and left edges of the top plate 19 and, by securing the stays 20, 20 to the lower surface of the upper wall 11a of the tank shell 11, the wave eliminating plate 12 is installed within the tank shell 11. The wave eliminating plate 12 is located approximately in the central part in the longitudinal direction of the tank shell 11, wherein the volume of a front space 21 of the wave eliminating plate 12 in the tank shell 11 is almost the same as that of a rear space 22 of the wave eliminating plate 12 (see FIG. 3).

Since the wave eliminating plate 12 of the present embodiment is simple in configuration as stated above, it makes manufacture easy. In particular, since the first inclined wall 16A and the second inclined wall 16B continuously exist to form one plane, it is possible to reduce the manufacturing cost by simplifying the shape of a mold adapted to press the first inclined wall 16A and the second inclined wall 16B. Furthermore, by simply securing two stays 20, 20 to the lower surface of the upper wall 11a of the tank shell 11, these can be installed to the tank shell 11 and thus, the assembling operation is quite easy.

Next, the action of the preferred embodiment of the present invention having the above-mentioned structure will be explained.

When sudden acceleration or deceleration of the vehicle is performed, the fuel within the tank shell 11 of the fuel tank moves backward or forward due to the inertia force, while when sudden turning of the vehicle is performed, fuel within the tank shell 11 of the fuel tank moves in a direction opposite to the turning direction due to centrifugal force. For this reason, the moving fuel collides with the side wall 11c of the tank shell 11 to jump upward and then, collides with the upper wall 11a, thereby generating the noise. Next, the fuel which bounced back after colliding with the side wall 11c repeatedly collides with other side wall 11c and as a result, the noise continues to be generated until the bounce attenuates. Especially in sudden acceleration or deceleration of the vehicle, a large inertia force is generated and the fuel swiftly moves in the longitudinal direction to make the noise large. In this case, the noise is reduced by suppressing the movement of the fuel by the wave eliminating plate 12.

Namely, in FIG. 3, when the fuel moves forward due to sudden deceleration of the vehicle, after the fuel within the rear space 22 of the tank shell 11 goes through the first inflow port 15A on the left side of the wave eliminating plate 12 to the front, the fuel is caused to change its flowing direction to an obliquely left front direction by the first inclined wall 16A to flow out of the first outflow port 17A to the front space 21 and generates a vortex in the front space 21, wherein the flow of fuel to the front within the front space 21 is weakened. As a result, in the front space 21, the fuel level is suppressed from vertically fluctuating to cause ruffles, wherein the momentum of the fuel colliding with the side wall 11c and the upper wall 11a of the tank shell 11 subsides and as a result, the generating noise is not only reduced, but also the momentum of the fuel returning from the side wall 11c subsides, thereby quickly attenuating the noise.

Adversely, in FIG. 3, when the fuel moves backward due to sudden acceleration of the vehicle, after the fuel within the front space 21 of the tank shell 11 goes through the second inflow port 15B on the right side of the wave eliminating plate 12 to the rear, the fuel is caused to change its flow direction to an obliquely right rear direction by the second inclined wall 16B to flow out of the second outflow port 17B to the rear space 22 and generates the vortex in the rear space 22, wherein the flow of the fuel to the rear within the rear space 22 is weakened. As a result, in the rear space 22, the fuel level is suppressed from vertically fluctuating to cause ruffles, wherein the momentum of fuel colliding with the side wall 11c and the upper wall 11a of the tank shell 11 subsides and as a result, the generating noise is not only reduced, but also the momentum of fuel returning from the side wall 11c subsides, thereby quickly attenuating the noise.

When the fuel within the tank shell 11 swiftly moves in the longitudinal direction due to the sudden acceleration or deceleration of the vehicle, there is a problem that the fuel returned at the side wall 11c reciprocates between the front space 21 and the rear space 22 to continue to generate the noise, but according to the present embodiment, when the fuel moves forward, the first inflow port 15A, the first inclined wall 16A and the first outflow port 17A function, while when the fuel moves backward, the second inflow port 15B, the second inclined wall 16B and the second outflow port 17B function to suppress the movement of the fuel, thereby being capable of quickly attenuating the noise.

In such a case, in the present embodiment, since the wave eliminating plate 12 is located approximately in the central part in the longitudinal direction of the tank shell 11, it is possible to secure sufficient space to generate the vortex in the front space 21 and the rear space 22 of the tank shell 11 and to get an effective noise-reduction effect irrespective of the moving direction of the fuel.

By the way, there is a place where the noise due to ruffles of the fuel is easy to generate in the tank shell 11. For example, a loud noise is generated at a place where the fuel is easy to collide because the upper wall 11a is low or at a place where the moving speed of the fuel is hard to attenuate because the inner wall surface is smooth. Accordingly, if the vortex is caused to generate aiming at such an area using the wave eliminating plate 12, the noise can be effectively reduced.

Further, since the upper section of the wave eliminating plate 12 is provided with the top plate 19 along the lower surface of the upper wall 11a of the tank shell 11, when the fuel tank becomes almost full, it is possible to block the fuel which is jumping up after colliding with the wave eliminating plate 12 by the top plate 19 and to exhibit the further noise-reduction effect by not letting the fuel collide with the upper wall 11a of the tank shell 11.

The preferred embodiment of the present invention was described above, but it will be obvious to those skilled in the art that various changes may be made without departing from the scope of the invention.

For example, the number of fuel passages consisting of the inflow port, the inclined wall and the outflow port is not limited to two, but it may be one or may be three or more.

Also, the inflow port may not always be directed to the longitudinal direction, while the outflow port may not always be directed to the horizontal direction.

1. A fuel tank for vehicles comprising:
a tank shell inside which a fuel is reserved and movable;
a wave eliminating plate disposed inside the tank shell and comprising inflow ports into which the fuel moving inside the tank shell flows and outflow ports from which the fuel flowing from the inflow ports flows out, wherein
the wave eliminating plate is configured such that a flowing direction of the fuel which flows out from the outflow ports is different from a flowing direction of the fuel which flows into the inflow ports.

2. The fuel tank for vehicles according to claim 1, wherein
the wave eliminating plate comprises
a main body which extends in a vehicle width direction, and
inclined walls which extend from the main body in a front-to-rear direction and the vehicle width direction such that the inflow ports are opened in the front-to-rear direction and the outflow ports are opened in the vehicle width direction, and
the inflow ports and the outflow ports are connected by the corresponding inclined walls, respectively.

3. The fuel tank for vehicles according to claim 2, wherein
the inflow ports comprise a first inflow port positioned at one side of the wave eliminating plate in the vehicle width direction and a second inflow port positioned at another side in the vehicle width direction, while the outflow ports comprise a first outflow port adapted to communicate with the first inflow port and a second outflow port adapted to communicate with the second inflow port, and
the first outflow port opens at the one side in the vehicle width direction and at one side in the front-to-rear direction with respect to the first inflow port, while the second outflow port opens at the another side in the vehicle width direction and at another side in the front-to-rear direction with respect to the second inflow port.

4. The fuel tank for vehicles according to claim 3, wherein the wave eliminating plate is located approximately in a central part of the tank shell in the front-to-rear direction.

5. The fuel tank for vehicles according to claim 2, wherein the inclined walls linearly connect the corresponding inflow ports and the corresponding outflow ports.

6. The fuel tank for vehicles according to claim 1, wherein the wave eliminating plate is provided with a top plate along a lower surface of an upper wall of the tank shell.
